(19) United States
(12) Patent Application Publication
(10) Pub. No.: US 2022/0377290 A1
(43) Pub. Date: Nov. 24, 2022

(54) Solar-Powered Wildlife Camera

(71) Applicants: John Hurst, Winter Garden, FL (US); Chad Parks, Winter Garden, FL (US); Travis Mathias, Winter Garden, FL (US)

(72) Inventors: John Hurst, Winter Garden, FL (US); Chad Parks, Winter Garden, FL (US); Travis Mathias, Winter Garden, FL (US)

(21) Appl. No.: 17/323,997

(22) Filed: May 18, 2021

(51) Int. Cl. H04N 7/18; H04N 5/33

(52) U.S. Cl. CPC H04N 7/188; H04N 5/33

(57) ABSTRACT

The solar-powered wildlife camera is a high-quality type of camera trap designed to operate by efficient use of power during the day or the night. The solar cell at the top of the device makes such efficiency possible. Said solar cell works in tandem with a lithium battery on the bottom of the device, drawing on its energy when necessary, and charging it when the solar cell generates excess energy. The solar-powered wildlife camera uses an infrared light and thermal trigger to activate the camera when motion is detected or when a heat signature is detected. Therefore, the camera is enabled to capture footage of wildlife during dark hours in addition to hours during the day. The camera device has strap mounts on its posterior to hold it upright. Alternatively, the bottom anchor can be used to mount on a post.

### BACKGROUND

Camera trapping is a method for capturing wild animals on film when researchers are not present, and has been used in ecological research for decades. In addition to applications in hunting and wildlife viewing, research applications include studies of nest ecology, detection of rare species, estimation of population size and species richness, as well as research on habitat use and occupation of human-built structures. Camera traps, also known as trail cameras, are used to capture images of wildlife with as little human interference as possible. There have been no products available as original equipment or as an aftermarket to address this problem.

Wildlife photography is a genre of photography concerned with documenting various forms of wildlife in their natural habitat. As well as requiring photography skills, wildlife photographers may need field craft skills. For example, some animals and birds are difficult to approach and thus a knowledge of the animal's and birds behavior is needed in order to be able to predict its actions. Photographing some species may require stalking skills or the use of a hide/blind for concealment. There have been no products available as original equipment or as an aftermarket to address this problem either.

There exists a need for a solar-powered wildlife camera that is not being met by any known or disclosed device or system of present.

### SUMMARY OF THE INVENTION

The solar-powered wildlife camera is a high-quality type of camera trap designed to operate by efficient use of power during the day or the night. The solar cell at the top of the device makes such efficiency possible. Said solar cell works in tandem with a lithium battery on the bottom of the device, drawing on its energy when necessary, and charging it when the solar cell generates excess energy. The solar-powered wildlife camera uses an infrared light and thermal trigger to activate the camera when motion is detected or when a heat signature is detected. Therefore, the camera is enabled to capture footage of wildlife during dark hours in addition to hours during the day. The camera device has strap mounts on its posterior to hold it upright. Alternatively, the bottom anchor can be used to mount on a post.

A camera device and system disclosed includes an infrared light source engineered to take a heat measurement of an environment and a heat measurement of an object moving therein. The disclosure also includes a camera configured to operate in a low light environment and film the object moving in the environment. The disclosure additionally includes a thermal trigger configured to trigger the infrared light and the camera by a predetermined difference in an environment heat and an object heat. The disclosure further includes a servomechanism configured to rotate the infrared light, the camera and the thermal trigger to track the object moving in the environment. The disclosure yet includes a housing for the infrared light, the camera, the thermal trigger and the servomechanism and accessories thereto.

### BRIEF DESCRIPTION OF THE DRAWINGS

FIG. 1 is a front view of the solar-powered wildlife camera in accordance with an embodiment of the present disclosure.

FIG. 2 is a back view of the solar-powered wildlife camera in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Throughout the present disclosure the term [term] is used to refer to [describe, rest of sentence]. The term [term] refers to [describe, rest of sentence].

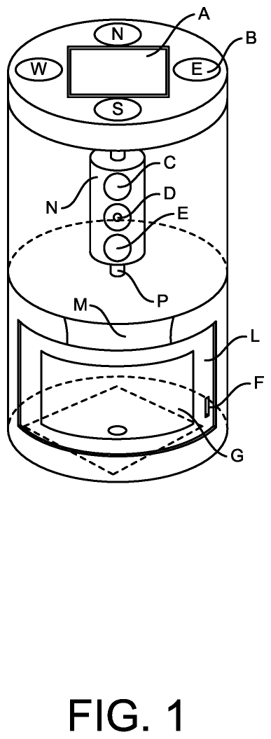

FIG. 1 is a front view of the solar-powered wildlife camera in accordance with an embodiment of the present disclosure. On the top of the camera, there is a low-light solar cell A. This powers the camera and its related functions. Also on the top of the camera is an automatic light emitting diode (LED) compass B. In the middle section of the camera device, there are three vertically stacked components: the infrared light C, the camera D, and thermal trigger that activates the camera when a heat signature is detected. The bottom section has a number of controls, such as a light emitting diode (LED) program screen F, a USB charging port F, and a flip lock door L to access the back-up power source batteries. The depiction also includes an automatic GPS (global positioned system) M, a servomechanism N and a pillar P.

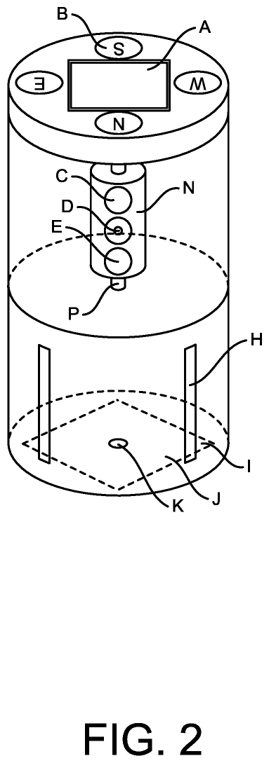

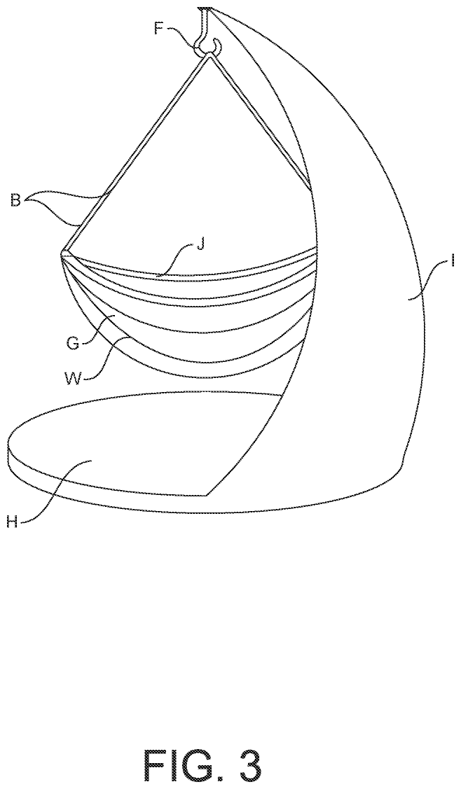

FIG. 2 is a back view of the solar-powered wildlife camera in accordance with an embodiment of the present disclosure. Again, the low light solar cell A, and the light emitting diode compass B are shown on the top of the camera device. The infrared light C, the camera D, and the thermal trigger E are shown in the middle section of the camera device. On the back of the bottom section, there are mounts for straps H. On the bottom of the camera device, there is an anchor K for a post mount, a lithium battery cover J, and screws to keep said cover in place I. The depiction also includes an automatic GPS component M, a servomechanism N and a mounting pillar P.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. A camera device comprising:
an infrared light source configured to take a heat measurement of an environment and a heat measurement of an object moving therein;
a camera configured to operate in a low light environment and film the object moving in the environment;
a thermal trigger configured to trigger the infrared light and the camera by a predetermined difference in an environment heat and an object heat; and
a servomechanism configured to rotate the infrared light, the camera and the thermal trigger to track the object moving in the environment.

2. The camera of claim 1, further comprising at least one of a low light solar cell and a battery backup for the camera device.

3. The camera of claim 1, wherein the servomechanism contains the camera device and rotates to track the object moving in the environment.

4. The camera device of claim 1, further comprising a pillar configured for the servomechanism to rotate thereon.

5. The camera of claim 1, further comprising a housing for the camera device and accessories and physical and electrical ports for the accessories.

6. The camera device of claim 1, further comprising an LED input/output screen for the camera device.

7. The camera device of claim 1, further comprising an automatic LED compass display on a housing for the camera device.

8. The camera device of claim 1, further comprising a flip lock door on a housing for the camera device.

9. The camera device of claim 1, further comprising a quarter inch post mount in a housing for the camera device whereon to mount the camera device.

10. The camera device of claim 1, further comprising an GPS (global positioning satellite) locator in a housing for the camera device.

11. The camera device of claim 1, further comprising a USB (Universal Serial Bus) type port in a housing for the camera device.

12. The camera device of claim 1, further comprising a strap mount defined in a housing for the camera device.

13. The camera device of claim 1, wherein the predetermined difference in the environment heat and the object heat is a nominal 98 degrees Fahrenheit.

14. The camera device of claim 1, wherein the servo mechanism tracks the object moving in the environment in a direction of a difference of position of the object in the environment.

15. A camera system comprising:
an infrared light source configured to take a heat measurement of an environment and a heat measurement of an object moving therein;
a camera configured to operate in a low light environment and film the object moving in the environment;
a thermal trigger configured to trigger the infrared light and the camera by a predetermined difference in an environment heat and an object heat;
a servomechanism configured to rotate the infrared light, the camera and the thermal trigger to track the object moving in the environment; and
a housing for the infrared light, the camera, the thermal trigger and the servomechanism and accessories thereto.

16. The camera system of claim 15, further comprising a pillar stationary to the housing for the rotation of the camera relative thereto.

17. The camera system of claim 15, wherein the predetermined difference in the environment heat and the object heat is predetermined to that of a wildlife game animal.

18. The camera system of claim 15, wherein the housing is sealed against a water penetration therein.

19. The camera system of claim 15, wherein the servo mechanism tracks the object moving in the environment in a direction of a difference of position of the object relative to the environment.

20. The camera system of claim 15, wherein the housing is stationary with respect to a mount for the camera system and the camera rotates relative thereto via the servomechanism.
